(19) United States
(12) Patent Application Publication
(10) Pub. No.: US 2015/0195039 A1
(43) Pub. Date: Jul. 9, 2015

(54) SYSTEM AND METHOD FOR INTERCHANGING DATA IN A HYBRID ETHERNET-BASED PASSIVE OPTICAL NETWORK

(71) Applicant: ALCATEL-LUCENT USA, INC., MURRAY HILL, NJ (US)

(72) Inventor: Thomas P. Chu, MURRAY HILL, NJ (US)

(73) Assignee: ALCATEL-LUCENT USA, INC., MURRAY HILL, NJ (US)

(21) Appl. No.: 14/149,157

(22) Filed: Jan. 7, 2014

(51) Int. Cl. H04B 10/27

(52) U.S. Cl. CPC H04B 10/27

(57) ABSTRACT

An interworking unit and a method of interchanging data between an optical network and a cable distribution network. In one embodiment, the interworking unit includes: (1) a cable line terminal module operable to communicate with a plurality of cable network units via a cable distribution network and (2) an optical networking unit module coupled to the cable line terminal module and operable to generate a message requesting registration of the interworking unit as an optical networking unit in an optical network and reporting a speed of the cable distribution network.

### TECHNICAL FIELD

This application is directed, in general, to Ethernet networks and, more specifically, to a system and method for interchanging data between the optical portion and the electronic portion of a hybrid Ethernet-based passive optical network (EPON).

### BACKGROUND

Broadband Internet access has become a vital service for many governments, businesses and households. Because of its high performance and comparative low cost, EPON has become the technology of choice for telecom service providers to offer fiber to the home, the building, the curb, etc. EPONs are often geographically extended using electronic (“cable”) networks. It has become advantageous to use a unified protocol to communicate data over both the EPON and the electronic network. The Institute of Electrical and Electronics Engineers (IEEE) uses the term, “EPON over cable,” or EPoC, to describe the use of EPON protocols over a cable distribution network (CDN). EPONs and their cable extensions (together called “hybrid EPONs”) are in wide use and expected to be the primary delivery mechanism for broadband Internet services for years to come.

### SUMMARY

One aspect provides an interworking unit. In one embodiment, the interworking unit includes: (1) a cable line terminal (CLT) module operable to communicate with a plurality of cable network units (CNUs) via a CDN and (2) an optical networking unit (ONU) module coupled to the cable line terminal module and operable to generate a message requesting registration of the interworking unit as an ONU in an optical network and reporting a speed of the CDN.

Another aspect provides a method of interchanging data between an optical network and a CDN. In one embodiment, the method includes: (1) causing an interworking unit to communicate with a plurality of CNUs via the CDN, (2) generating a message in the interworking unit requesting registration of the interworking unit as an ONU in the optical network and (3) reporting a speed of the CDN via the optical network.

Yet another aspect provides a hybrid EPON-EPoC network. In one embodiment, the hybrid EPON-EPoC network includes: (1) a CDN coupled to a plurality of CNUs, (2) an EPON, (3) an interworking unit, having: (3a) a CLT module coupled to the CDN and operable to allow the plurality of CNUs to communicate via the EPON and (3b) an ONU module operable to cause the interworking unit to be registered with an OLT as an ONU in the EPON and report a speed of the CDN to the OLT.

### BRIEF DESCRIPTION

Reference is now made to the following descriptions taken in conjunction with the accompanying drawings, in which:

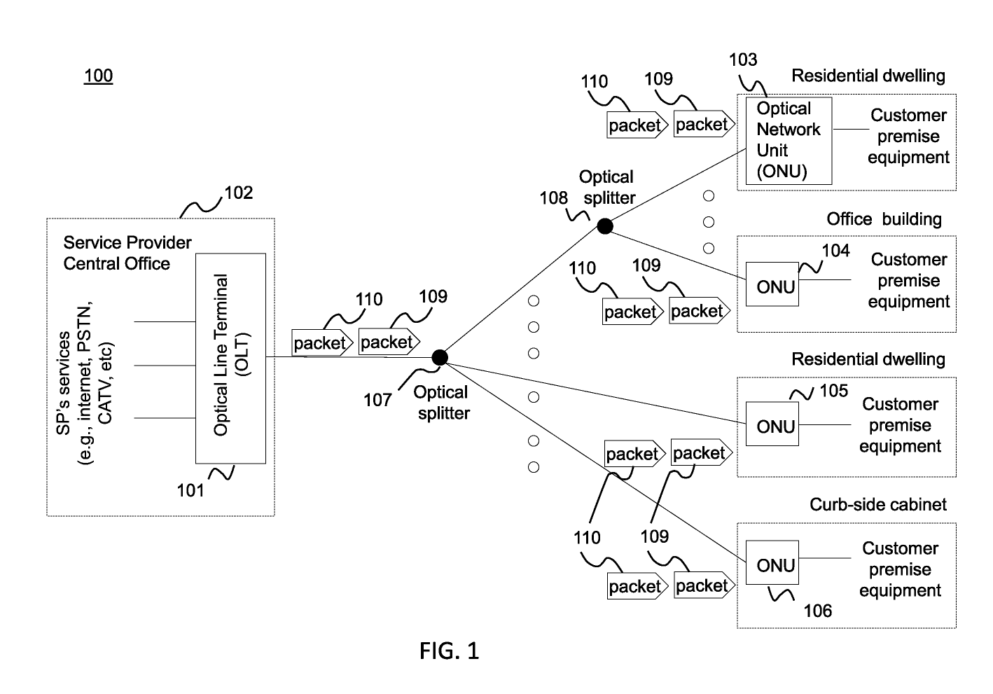

FIG. 1 illustrates data flow in the downstream direction in an EPON;

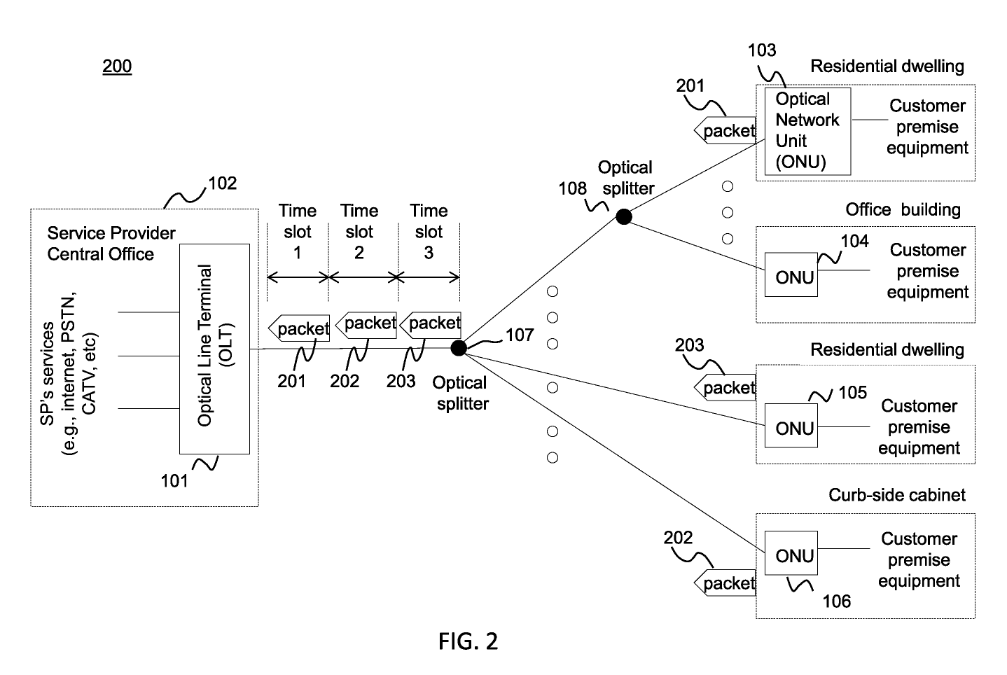

FIG. 2 illustrates data flow in the upstream direction in an EPON;

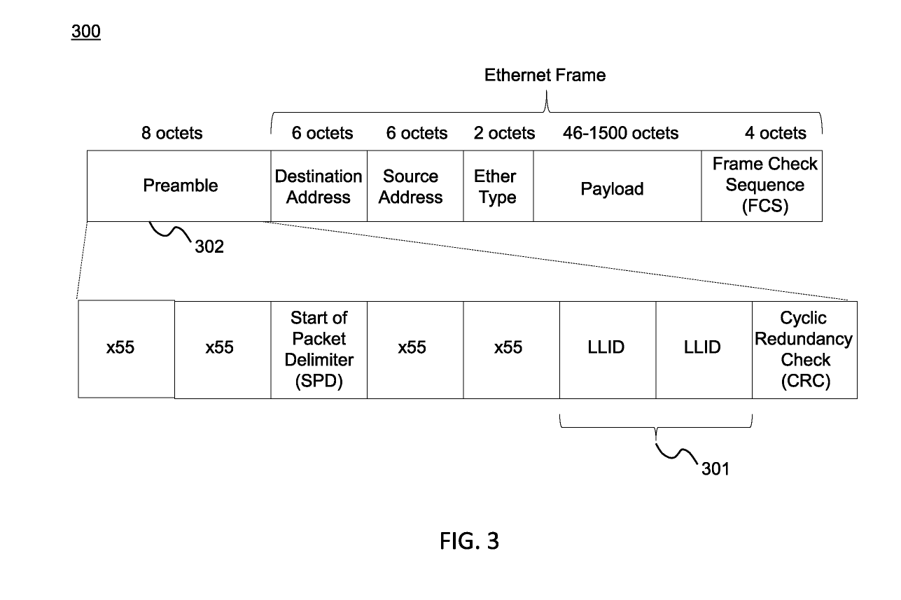

FIG. 3 illustrates the format of an EPON Message;

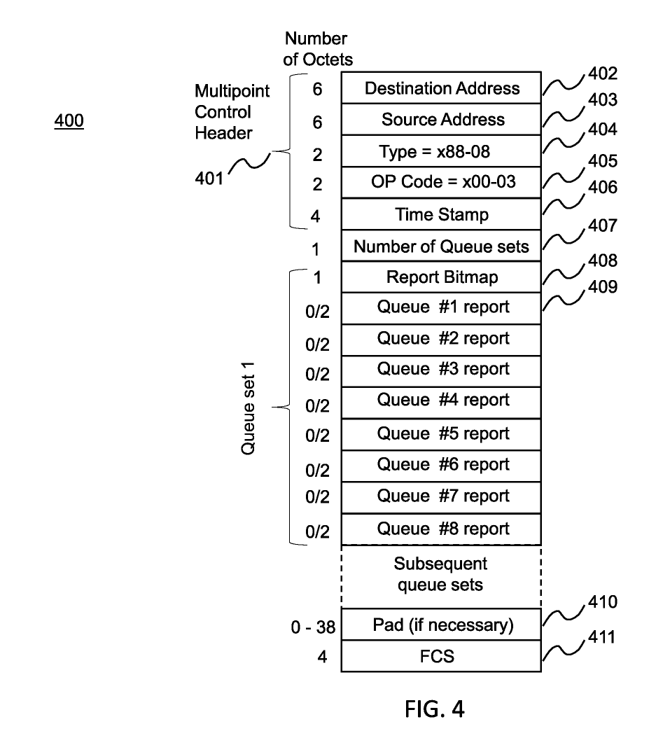

FIG. 4 illustrates the format of an EPON REPORT message;

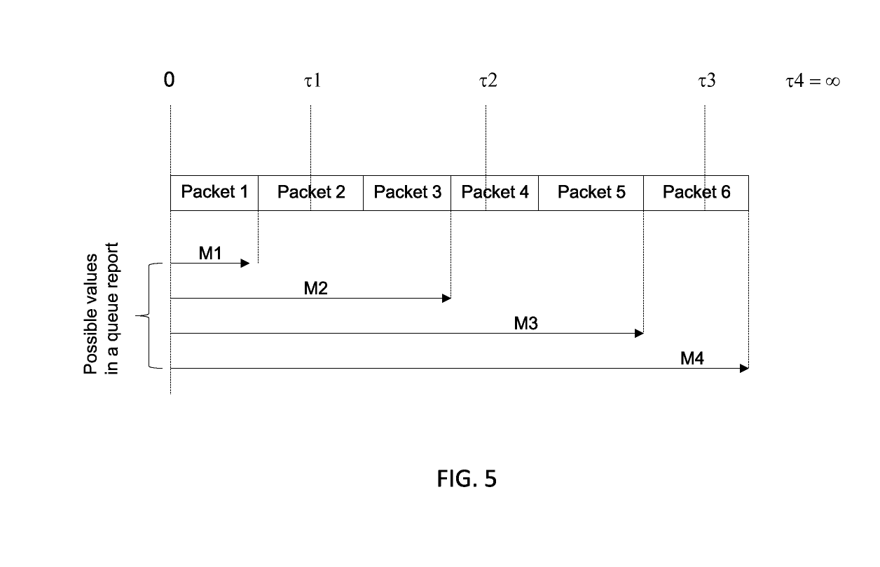

FIG. 5 illustrates the concept of threshold reporting in reporting queue status;

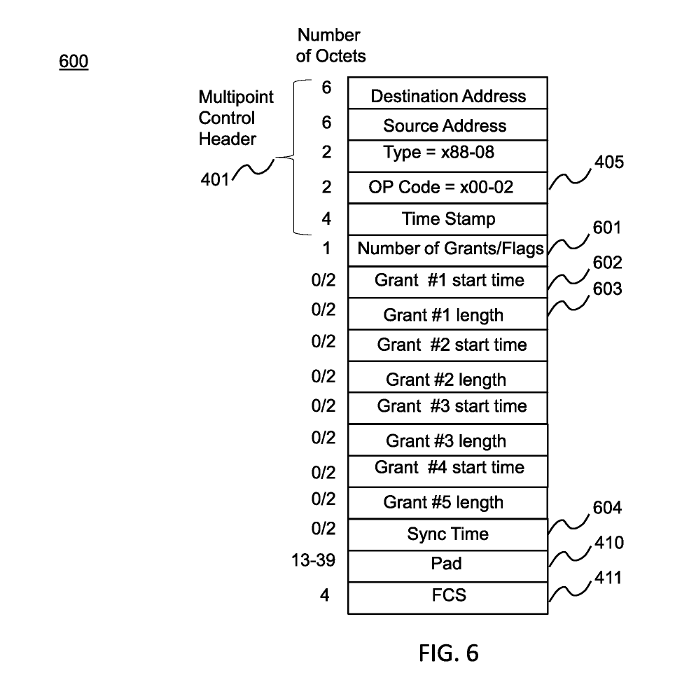

FIG. 6 illustrates the format of an EPON GATE message;

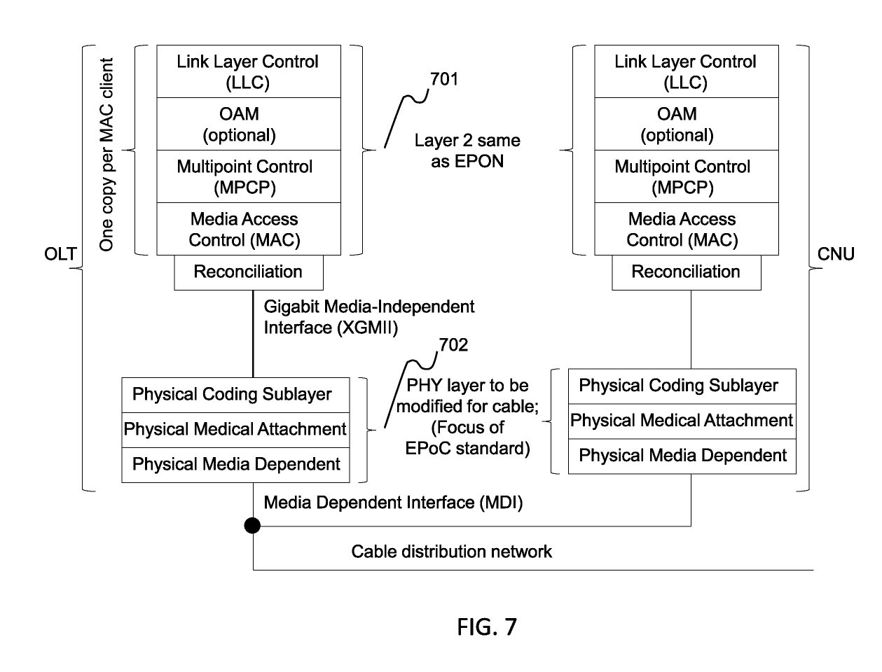

FIG. 7 illustrates the focus of the EPoC standard;

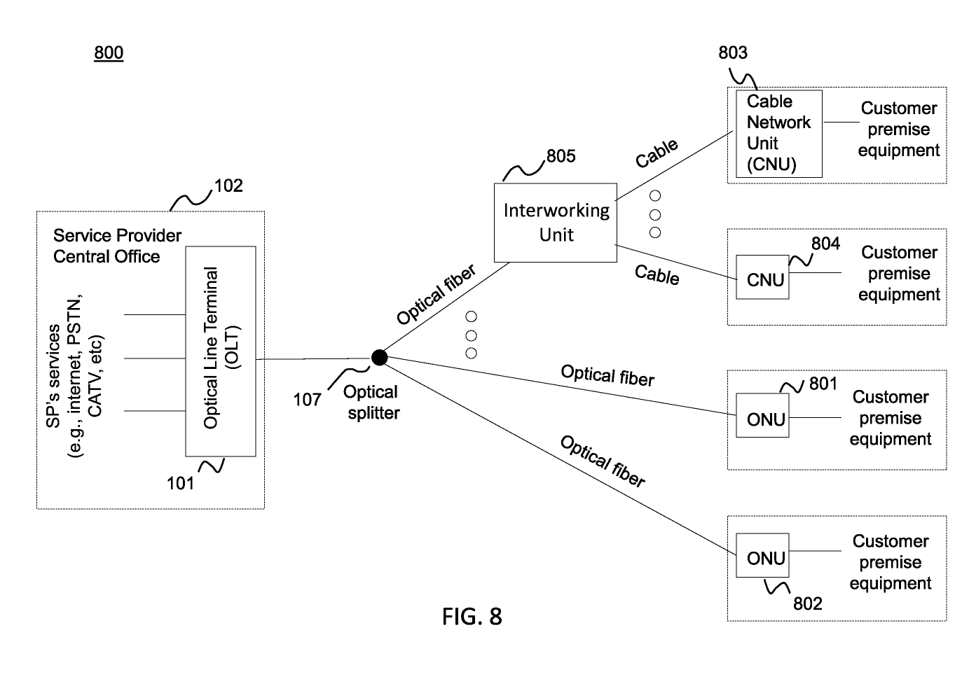

FIG. 8 illustrates a hybrid EPON-EPoC network;

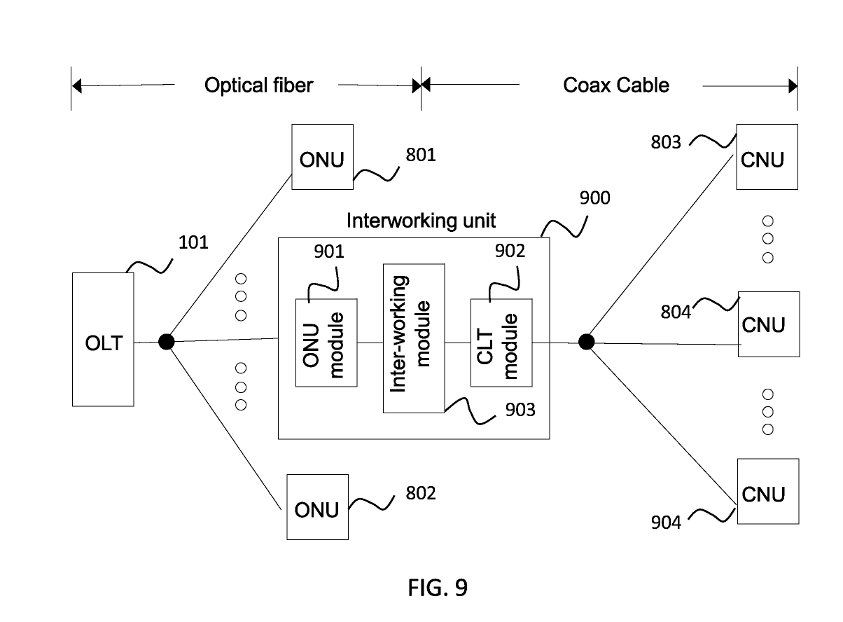

FIG. 9 illustrates an interworking unit according to one disclosed embodiment;

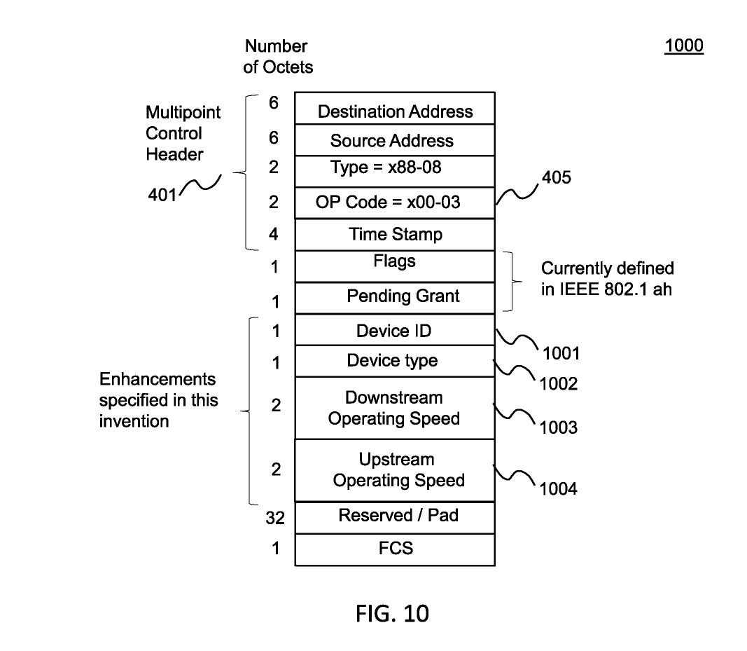

FIG. 10 illustrates an enhanced REGISTER-REQ message to support registration of devices such as EPoC interworking units according to one disclosed embodiment;

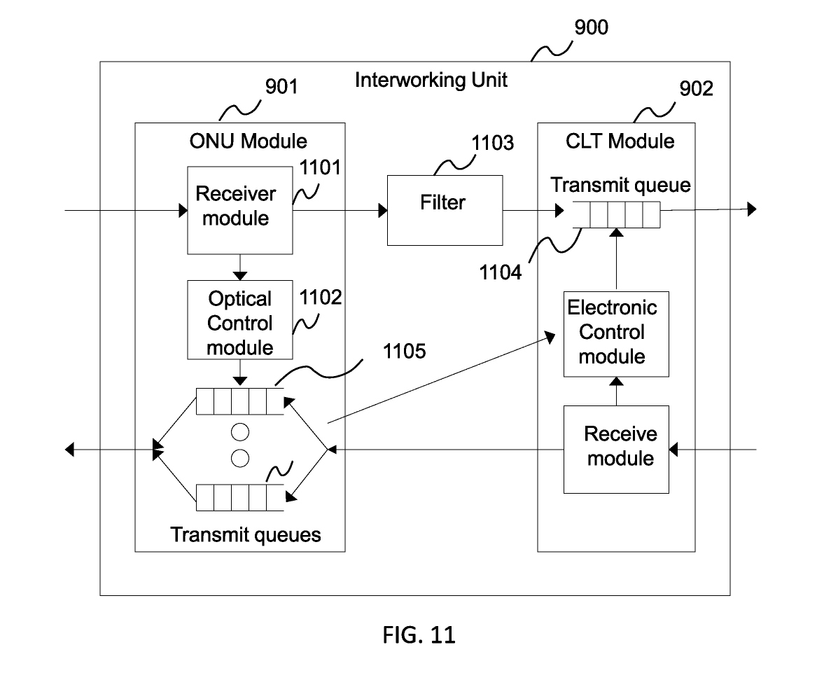

FIG. 11 illustrates an exemplary nodal architecture of the interworking unit according to one disclosed embodiment;

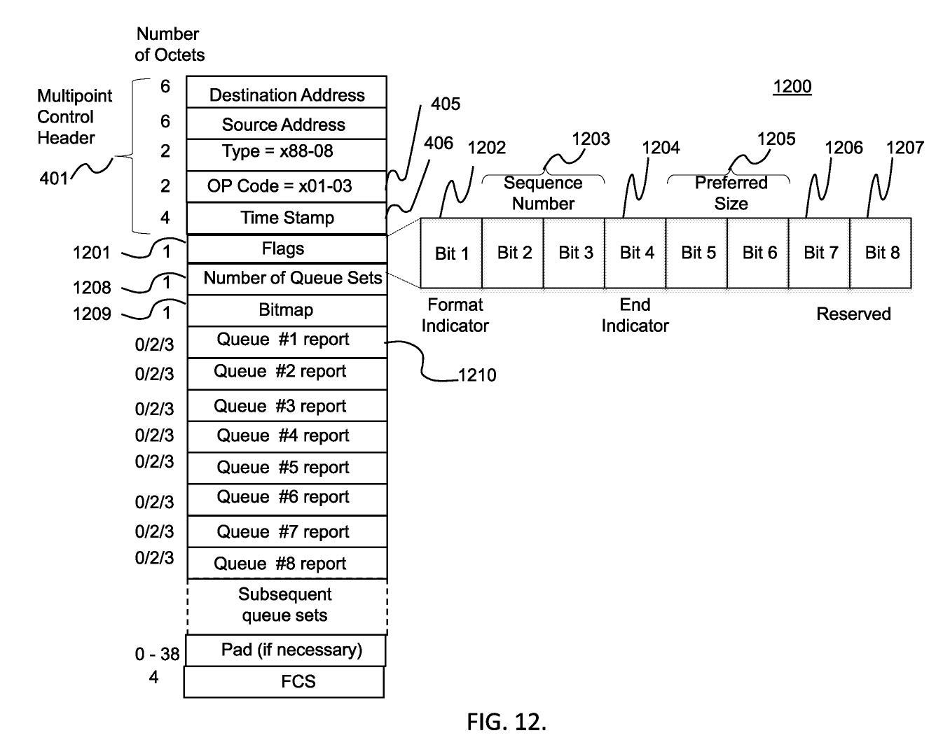

FIG. 12 illustrates an enhanced REPORT message according to one disclosed embodiment;

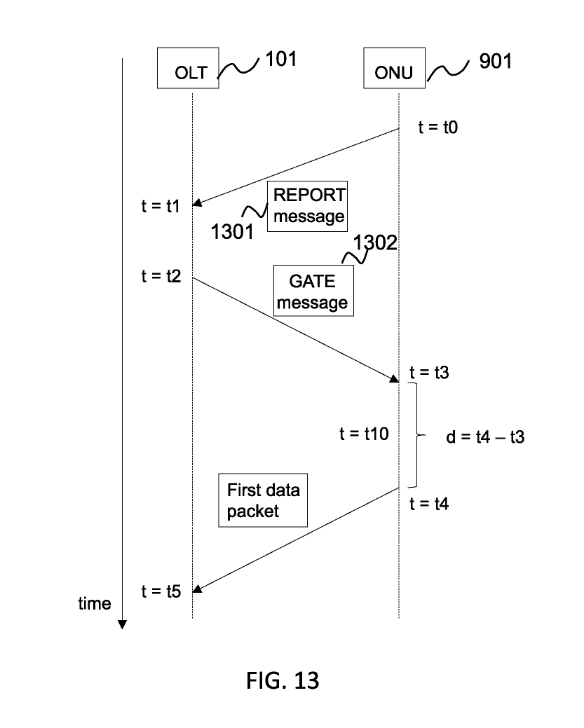

FIG. 13 illustrates an example data flow between an OLT and an ONU module according to one disclosed embodiment; and

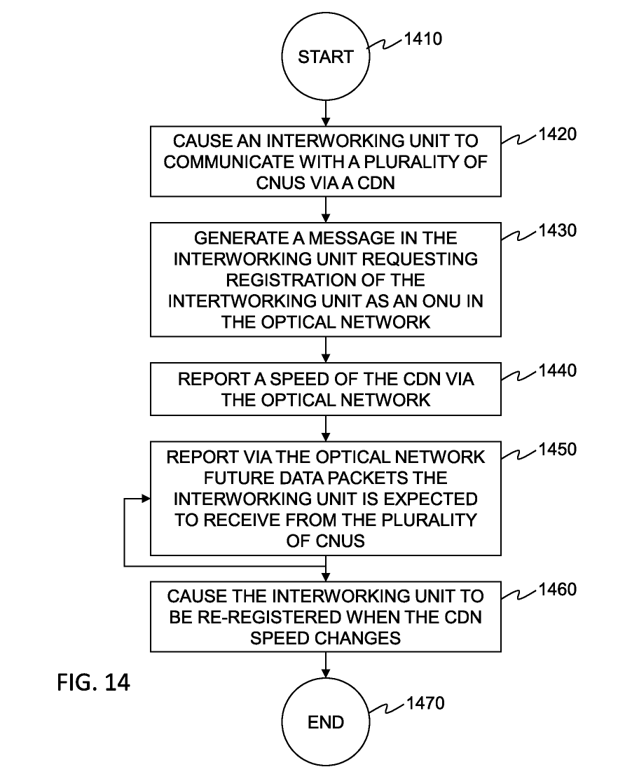

FIG. 14 is a flow diagram of one embodiment of a method of interchanging data between an optical network and a CDN.

### DETAILED DESCRIPTION

It is realized herein that, while high data rates are possible in a hybrid network, inefficiencies remain. It is more specifically realized herein that the manner in which data is communicated between the EPON and the cable extension may be made more efficient. Accordingly, various embodiments of a system and method for interchanging data between the optical portion and the electronic portion of a hybrid EPON will be disclosed and described herein.

In general, the system and method provide, through the use of a novel interworking unit, an architecture and method that interconnect an EPON with downstream EPoC networks (i.e. forming a hybrid EPON-EPoC network). The interworking unit appears as an ONU to the OLT at the central office, and, at the same time, as the CLT for all the cable network units (CNUs) in the same CDN attached to the interworking unit. A salient point is that the EPON is decoupled from the CDN. The CDN could, and likely would, be operating at a different speed, both upstream and downstream, than the EPON. Multiple interworking units are possible for a given EPON, and multiple CNUs may be concurrently attached to the EPON through the interworking units. The various CDNs networks attached to the interworking units can operate at different speeds.

As an aside, while the term, CDN, implies use of a cable, and perhaps even a coaxial cable, for communication, the term is used more broadly herein to include any distribution network that may cooperate with an optical network to form a hybrid network. Thus, a CDN may be a wireline or wireless electronic network, or even an optical network of any conventional or later-developed type. If the interworking unit is to report the availability of future packets, an important characteristic of the CDN is that it be such that the interworking unit is able to report the availability of future packets with a high degree of certainty.

Certain embodiments of the interworking unit employ a modified REGISTER-REQ message that allows a device to identify its type to the OLT when it registers. Other important information, such as downstream and upstream speed of the attached CDN for interworking units can also be reported upon registration. A novel, enhanced REPORT message is introduced, by which an interworking unit can report “future data packets” which the interworking unit is expected to receive from the CNUs in the future. With this novel message, the OLT can allocate resources to allow the transmission of these “future packets” reducing latency with little or no loss of bandwidth efficiency.

The interworking unit functions primarily in the EPON. No assumption is made about the EPoC network. Therefore, the interworking unit can readily support other type of networks as long as the interworking unit is aware of, with sufficient certainty, data packets arriving from downstream in the future. “sufficient certainty” is typically gained through reports received by the interworking unit. Examples are other EPONs, wireless networks, etc.

EPON is specified in the IEEE 802.3ah-2004 (see, IEEE 802.3ah, “Part 3: Carrier Sense Multiple Access with Collision Detection (CSMA/CD) Access Method and Physical Layer Specifications. Amendment: Media Access Control Parameters, Physical Layers, and Management Parameters for Subscriber Access Networks”, June 2004) and 802.1v-2009 suite of standards. The EPON standard specifies an EPON as the physical layer and Ethernet as the layer 2 in providing high-speed access service.

FIG. 1 illustrates downstream transmission in an EPON 100. As those skilled in the pertinent art understand, EPON operates on a tree topology. The high end of the optical tree network is an OLT 101, which is usually located at a central office (CO) 102. Connected to the OLT are a number of ONUs. FIG. 1 shows four ONUs: ONU 103, 104, 105, 106. The ONUs can be located in residential dwellings, office buildings, curb-side cabinets, etc. Passive optical splitters, such as the passive optical splitters 107, 108, are used to connect the OLT and the ONUs. In the downstream direction, the splitters split the downstream optical signals from one fiber to several fibers. In the upstream direction, the splitters combine multiple optical signals from multiple fibers into a single signal. As FIGS. 1 and 2 illustrate, multi-level splitting is supported. Connected to the ONUs are customer premise equipment (CPE), while the OLT is connected to the various services offered by the service providers (e.g., PSTN, Internet access, CATV).

In the downstream direction, EPON uses time-division multiplexing (TDMA). All packets are transmitted downstream regardless of their intended destinations. In this example of FIG. 1, the OLT 101 transmits a packet 109 destined for the ONU 103 and a packet 110 destined for the ONU 106. All ONUs in the network receive both packets. Encoded in the preamble of the EPON packet is a Logical Link ID (LLID). The LLID indicates the destination ONU of the packet. Multiple LLIDs can be assigned to an ONU, but each LLID uniquely identifies the ONU. Based on the value of the LLID, the ONU 106 forwards only the packet 110 to the CPE, while the ONU 103 only forwards packet 109. The ONUs 104, 105 discard both packets.

In the upstream direction, EPON uses Time-Division Multiple Access (TDMA). The OLT subdivides time into a number of time slots, each time slot being 16 nanoseconds (ns) long. The OLT allocates the time slots to the ONUs dynamically based on status reports from these ONUs as well as the policy at the OLT. The OLT can assign a number of contiguous slots to an ONU for transmission so that packets of varying sizes can be sent without segmentation. The allocation message from OLT indicates when an ONU can start to transmit upstream and the amount of the data that can be transmitted, in terms of number of time slots. The OLT ensures that the uplink data packets from different ONUs do not interfere with each other. FIG. 2 illustrates the operation of EPON for upstream traffic 200. In FIG. 2, the OLT 101 has allocated time slot 1 to ONU 103 to transmit a packet 201, time slot 2 to the ONU 106 to transmit a packet 202, and time slot 3 to the ONU 105 to transmit a packet 203. The ONUs send their packets at the appropriate times, as the OLT instructs. The packets arrive at the OLT at the proper times without interfering with each other. Note that, in this example, all the packets happen to be one time slot long. In practice, packets can be of any length, up to the maximum allowable length as specified in the standard. EPON supports 10 Gbps for downstream transmission and either 10 Gbps or 1 Gbps for upstream transmission.

FIG. 3 illustrates an EPON packet 300. Note the presence of the LLID field 301 in the preamble 302 as described previously.

The Multipoint Control Protocol (MPCP) has five message types: GATE, REPORT, REGISTER-REQUEST (REGISTER-REQ), REGISTER, and REGISTER-ACKNOWLEDGE (REGISTER-ACK). The REPORT and GATE messages are used for dynamic time slot allocation, while the REGISTER messages are used for ONU registration. All five multipoint control messages contain the following fields: (1) Destination MAC Address, (2) Source MAC Address, (3) Type, encoded with the value x88-08 to indicate that the packet is an MPCP message, (4) Op Code, encoded to indicate the type of MPCP message such as GATE, REPORT, etc., (5) Timestamp, (6) Payload, and (7) FCS. The Timestamp field conveys the contents of the LocalTime register at the time of the transmission of the message. One use of this field is for the OLT to compute the Round-Trip Time (RTT) between the OLT and a given ONU. The Payload field contains the contents of the message. Its encoding depends on the message type. Padding may be added to satisfy the minimum message-size requirement. The FCS may be used to check whether there are errors in the packet.

The REPORT and GATE messages will now be described in more detail. REPORT messages are sent by ONUs to inform the OLT of the status of its upstream transmit queues. Each REPORT message is specific to a LLID that is assigned to the ONU. If the ONU is assigned a number of LLIDs, a REPORT message must be sent for each LLID. Each LLID can be associated with up to eight transmit queues.

FIG. 4 illustrates a REPORT message 400. The REPORT message 400 contains a Multipoint Control (MCP) header 401 containing a Destination Address field 402, a Source Address field 403, a Type field 404, an Op Code field 405, and the Time Stamp field 406, as described above. The op code is x00-03 for a REPORT message. The REPORT message 400 further contains a Number of Queue Sets field 407 containing the number of queue sets in the message. In addition, for each queue set, the REPORT message 400 contains a one-octet-long Bitmap field 408 that indicates the presence or absence of a queue report 409 for a particular queue and, if present, such queue reports. A queue report 409 is two octets long and encodes the queue length of the corresponding queue in units of time slots at the time of the report. The REPORT message 400 further contains a pad 410 a number of octets long, if necessary, and an FCS 411. Presence of a queue report for a particular queue is indicated in the report Bitmap 408.

EPON uses the concept of threshold reporting to encode the queue reports. A number of thresholds, up to 13 in the illustrated embodiment, can be configured for a queue. When encoding the queue reports for a queue, the ONU could report, in time slots, the size of all the integral packets just below a threshold. Consider the example illustrated in FIG. 5, where six packets reside in a particular queue. Associated with this queue are four thresholds: τ1, τ2, τ3, τ4 and four messages M1, M2, M3 and M4. The value of the last threshold τ4 can be set to infinity, so that the cumulative size of all packets in a queue can be reported. In this example, only packet 1 is totally below threshold τ1, and so the queue report associated with τ1 would be the size of packet 1, in units of time slots. Similarly, the queue report associated with τ2 would be the total size of packets 1, 2, and 3. The queue report associated with τ4 would be the total size of all the packets in this queue. In general, the ONU would report one queue set, which contains information for all active queues. As the payload of the REPORT messages is limited to 40 octets, the rest of the queue sets are usually encoded at the discretion of the ONU (e.g., only queue reports for the higher priority queues).

FIG. 6 illustrates the format of a GATE message 600. GATE messages are sent by the OLT to allocate bandwidth to ONUs. The GATE message 600 contains the MPC Header 401, wherein the op code 405 for a GATE message is x00-02. The GATE message 600 further contains a one-octet Grants/Flags field 601 containing information on the number of grants and related flags, described in further detail below. The GATE message 600 further contains for each grant, a Start Time field 602 containing the start time of the transmission and a Length field 603 containing the length of the transmission. In the illustrated embodiment, the start time for each grant is determined by the OLT as follows. Let the current time be t0 at the OLT. If the OLT wants to receive the signal from an ONU at time t1, then the OLT encodes the Start Time field of the grant with the value t2=t1−t0−RTT, where RTT is the estimated round-trip time. Upon receipt of the grant, the ONU transmits its message after waiting a period of t2.

The GATE message 600 further contains a Sync Time field 604 included only in discovery GRANT messages, a pad 410 a number of octets long, and the FCS 411. The Sync Time field, only included for discovery GRANT messages described below, informs an unregistered ONU of the time that the OLT requires to synchronize the received signal. The ONU should send idle code for this period of time before sending its REGISTER message.

The Grants/Flags field 601 is encoded as follows. The first three bits, bits 0-2, are used to encode the number of grants granted in GATE message 600. Up to four grants can be included. The next bit, bit 3, is used to indicate whether GATE message 600 is a normal GATE message or a discovery GATE message. A normal GATE message is a GATE message that an OLT sends to a specific ONU, giving the ONU permission to transmit at specific times. Discovery GATE messages are broadcast over the network giving the grant to all unregistered ONUs, so that they can send their REGISTER messages to the OLT to register themselves with it. The next four bits, one bit for each grant, are used to instruct the ONU whether a REPORT message should be sent at the end of the transmission for each grant.

Note that a grant is allocated to an LLID and not to individual queues of the LLID. Upon the receipt of a grant, it is up to the ONU to decide the transmission order of the packets among the queues.

The OLT dynamically allocates bandwidth to the ONUs based on information from the REPORT messages. One Dynamic Bandwidth-Allocation (DBA) algorithm is the IPACT algorithm. In IPACT, the OLT allocates bandwidth to the ONUs in a round-robin fashion. When the OLT allocates a grant to an ONU, the OLT allocates enough time so that the maximum amount of data as indicated in the REPORT message can be transmitted (plus one additional time slot for a REPORT message). To prevent a single ONU from hoarding the system, the OLT may place an upper limit to the size of a grant to an ONU. The advantage of the IPACT system is that it is very bandwidth-efficient, since no bandwidth assigned to an ONU would ever be wasted, as the OLT only allocates the time slot knowing that the data is available at the ONU to be transmitted. However, between the time that the ONU sends its REPORT message and the time that the ONU is instructed to transmit, data may be arriving at the ONU, the data arriving in this period cannot be transmitted until the next GATE message. Therefore, the IPACT algorithm may introduce more latency than other DBA algorithms, as data may have to wait longer at the transmit queue.

Other DBA algorithms have also been proposed. The most common family of algorithms involves allocating extra bandwidth to an ONU in anticipation of incoming traffic to the ONU. These are usually referred to as predictive DBA. Many variations exist, such as constant credit, linear credit, predictive credit, etc. with varying degrees of complexity and accuracy of prediction. In general, these algorithms would introduce less latency than IPACT but at the expense of bandwidth efficiency.

Many cable service providers are interested in providing Ethernet service by providing EPON over C (EPoC). FIG. 7 is an illustration, from the protocol-architecture point of view, of the focus of the IEEE EPoC standard effort. EPoC has the same logical architecture of EPON. The general concept is to keep “layer 2” 701 of EPON intact, while changing the physical (PHY) layer 702 to accommodate cable. This standard is currently being developed in the IEEE 802.3 standard working group. One point of note is that the final standard may support a number of operating speeds for both upstream and downstream transmission, to accommodate cable distribution plans of different characteristics, as well as the number of channels that are allocated to support the Ethernet service.

A common practice for cable service providers is to deploy optical fiber to an aggregation point near a group of subscribers (e.g., a neighborhood or a business building). The existing CDN is used to deliver services to the subscribers. FIG. 8 illustrates such a EPON-EPoC hybrid network 800. With this physical topology, EPON can be used over the fiber portion of the network, while EPoC would be used for the cable portion of the network. FIG. 8 is similar to FIGS. 1 and 2. OLT 101 resides at central office 102. ONU 801 and ONU 802 are connected directly to the OLT through the EPON. CNUs 803, 804 are attached to the CDN. They are connected to an interworking unit 805, which couples the CDN with the EPON.

Various embodiments of the interworking unit 805 are possible. Only some embodiments are described in detail herein. In these embodiments, the interworking unit appears as an ONU to the OLT at the central office and as the CLT for all CNUs in the CDN attached to the interworking unit 805. Thus, the EPON is decoupled from the CDN.

The CDN could and likely would be operating at a different speed, both upstream and downstream, than the EPON. In practice, the operating speed of the CDN depends on a number of factors, such as the bandwidth allocated for the Ethernet service, the quality of the network, environmental conditions, etc. In fact, because of changing environmental conditions, the CDN may operate at different speeds at different times.

By decoupling the EPON from the CDN, the interworking unit isolates changes in the CDN from the EPON. Multiple CDNs can be attached downstream from the EPON, with each CDN attached to a logically separate interworking unit. Each individual CDN can operate at its own individual speed, possibly different from that of other CDNs.

FIG. 9 illustrates an embodiment of the interworking unit. In this embodiment, the interworking unit 900 has three major components: a logical ONU module 901, a logical CLT module 902 and an interworking module 903. The ONU module 901 is connected to the OLT 101 at the CO. On the same EPON, other ONUs, such as the ONU 801 and the ONU 802, may also be connected to the OLT 101. These ONUs may be standalone ONUs or logical ONUs residing in other interworking units. The CLT module 902 acts as a CLT to the CNUs, such as the CNUs 803, 804, 904, that are attached to the same CDN as CLT module 902. Interconnecting the ONU module 901 and the CLT module 902 is the interworking module 903, which is operable to facilitate and manage the transfers of Ethernet packets between the two modules.

Some enhancements to the EPON registration process will now be described. As specified in the EPON standard, an ONU registers with the OLT when the ONU first powers up. After the initial registration, the ONU re-registers at regular intervals. Thus, the ONU module in an interworking unit would also register with the OLT as specified in the EPON standard. However, the illustrated embodiment enhances the REGISTER-REQ message. When an interworking unit registers with the OLT, the enhanced REGISTER-REQ message includes the following additional information: ONU ID, ONY type, upstream operating speed, and downstream operating speed.

FIG. 10 illustrates an embodiment of the enhanced REGISTER-REQ message 1000. A Device ID field 1001 is used to uniquely identify the interworking unit that is registering. Multiple LLIDs can be assigned to an interworking unit. The MAC client at the interworking unit for each LLID may have a different MAC address. A Device Type field 1002 is used to indicate the type of ONU that is registering. For example, the Device Type field 1002 is set to indicate that the ONU is an interworking unit. An Upstream Operating Speed field 1003 is used to indicate the current upstream operating speed of the CDN. A Downstream Operating Speed field 1004 is used to indicate the current downstream operating speed of the CDN. In one embodiment, the REGISTER-REQ message has 35 reserved/pad octets. In one specific embodiment, some of the reserved/pad octets can be used to convey the above information. In the illustrated embodiment, the ONU module 901 registers again whenever the CDN changes speed.

In response to the REGISTER-REQ message, the OLT sends the REGISTER message to the ONU module, indicating whether it accepts or rejects the registration request from the ONU module. In one embodiment, the above information is echoed in the REGISTER message. Similar to the case of the REGISTER-REQ message, the echoed information can be encoded using the reserved/pad octets in the REGISTER message.

Since the CDN usually operates at a much lower speed than the EPON, the OLT should avoid sending an excess amount of packets to an interworking unit as the packets may be discarded because of buffer overflow. Since the OLT is aware of the current downstream speed of the CDN that is attached to the interworking unit (through the enhanced REGISTER-REQ message described in the preceding paragraph), the OLT can limit the number of packets sent to the CDN downstream from an interworking unit. The traffic that is under rate control includes both unicast and multicast traffic that are for CPE that are attached to the CDN of the interworking unit. If the span of a multicast group is not known, packets destined for that multicast group are forwarded to all the CDNs and so they will come under rate control at the OLT for all interworking units. However, packets that are destined only for the ONU modules are not forwarded to the CDNs and so these packets are not under rate control. Examples of these packets are EPON MPCP control packets.

Downstream packet processing at the interworking unit will now be described. FIG. 11 is a detailed decomposition of an embodiment of the interworking unit 900. A receiver module 1101 of ONU module 901 is operable to demodulate the incoming signal from the OLT. Once the packet is extracted, an ONU module 901 is operable to determine whether packet is a control/management packet for the ONU or the packet is a user packet. If the packet is a control packet, the receiver module 1101 forwards the packet to an optical control module 1102 to be processed. If it is a user packet, the receiver module 1101 forwards the packet to a filter 1103.

The filter 1103 is operable to determine whether the packet is destined for devices that are attached to the CDN. The packet is only forwarded if it is destined for devices that are attached to the CDN. Otherwise, the packet is discarded. The interworking unit 900 can acquire the MAC addresses for the devices attached to the CDN through a number of means such as the EPoC registration process for CNUs, a learning process (i.e. observing and remembering the source addresses of packets from the CDN), or by administrative means. After passing the filter 1103, the packet is placed in a downstream transmission queue 1104 of the CLT module 902, queued for transmission downstream over the CDN.

Upstream packet processing at the interworking unit 900 will now be described. The CLT module 902 gives grants to downstream CNUs using GATE messages. It receives packets from a CNU at the time slot that is allocated to that particular CNU. The CLT module 902 examines the header of the incoming packets and, based on the information collected, forwards the packet to a transmission queue 1105 at the ONU module 901. The ONU module 901 transmits the packet to the OLT upon the receipt of a GATE message with the appropriate grant.

With the current REPORT message, system operation is not efficient. In the illustrated embodiment, the REPORT message is enhanced to improve the performance of the system. A relatively simple example will illustrate this.

For the purposes of the example, the ONU module 901 of the interworking unit 900 is assumed to have only a single transmit queue; the current time is set to t=0; packet size and time are measured in terms of time slots; the size of a time slot is different for the EPON and the CDN(s); the time slot of the EPON will be used as the unit of measurement; two packets are in the ONU buffer, of size 30 and 40 time slots respectively; and the interworking unit 900 is expecting to receive a packet of size 90 time slots from one CNU at time t=90, and another packet of size 80 time slots from another CNU at t=170. Under conventional operation, if the ONU module 901 is sending a REPORT message upstream now, the REPORT message would include two queue reports in two queue sets: one queue report indicating a queue length of 30 time slots, and the other queue report indicating a queue length of 70 (=30+40) time slots. If the OLT decides to instruct the interworking unit 900 to transmit at t=180, the OLT could grant a transmission of length 70 time slots so that both packets at the transmit queue could be transmitted (assuming that the OLT uses the conventional IPACT algorithm, rather than any predictive algorithm). However, at t=101>90, the interworking unit 900 has already received the packet from the first CNU. This packet has to wait until the next transmission cycle for the interworking unit 900. Alternatively, if the OLT decides that the interworking unit 900 should transmit at t=201>170, packets from both CNUs will have already arrived by then and would be available for transmission. A grant of 70 time slots would force both packets to wait until the next transmission cycle, resulting in degraded system performance.

The use of predictive algorithms may improve the response time but at the expense of bandwidth efficiency, as the prediction may not be accurate 100% of the time. A novel REPORT message is introduced that allows the ONU module 901 to report upstream information about packets that it expects to receive in the future with high certainty. In the above example, the new REPORT message allows the interworking unit 900 to report, as a queue report, a queue length of 150 time slots (=30+40+80) at a future time of at least 80 time units, and also a queue length of 240 time slots at a future time of at least 170 (=90+80) time units.

FIG. 12 illustrates an embodiment of an enhanced REPORT message 1200. The message is a MPCP message and follows the structure of an MPCP message. Since this is a new type of MPCP message, however, a new value for the Op Code field 405 is used. In the embodiment shown in FIG. 12, the value x01-03 is used. Any other unused value may also be used.

Following the Time Stamp field 406 is an 8-bit Flags field 1201, which is encoded as follows. The first bit is a Format indicator field 1202 used to indicate whether the queue reports in this message are two or three octets long. In the illustrated embodiment, an ONU can send up to four messages for the same report. Each message still requires one time slot, and they should be transmitted contiguously (i.e. one after another). Therefore, the ONU decides the number of messages to transmit based on the amount of available time slots for reporting. All the messages in the same report have the same time stamp, which has the value of when the first message is sent. The second and third bits together constitute a Sequence Number field 1203 are used to indicate whether this message is the first, second, third, or fourth message of a complete report. The fourth bit is an End Indicator field 1204, used to indicate that this message is the last message of a complete report. The fifth and sixth bits together constitute a Preferred Size field 1205. This field is used by the CNU to indicate its preference for the number of messages (up to 4) for the next report. Even though an ONU can express its preference, it is up to the OLT to decide the amount of time slots allocated. In the illustrated embodiment, Bits 7 and 8 1206, 1207 are reserved.

The next field is the Number of Queue Sets field 1208, which is the same as in the current REPORT message. The first octet of each queue set is the Bitmap field 1209, which is used to indicate the presence or absence of a queue report, as in the current REPORT message. In the illustrated embodiment, however, a queue report 1210 can be either two or three octets long, as indicated in the flags field 1201 described above. If a queue field 1210 is two octets long, it is used to encode the length of the queue buffer, the same as the current REPORT message. If a queue field 1210 is three octets long, the third octet is used to encode the future time, in units of time slots after the enhanced REPORT message is sent, that the queue length as encoded is realized. This third octet will be referred to herein as the “Future Time” field.

When sending a report that consists of multiple messages, different messages can use different formats for the queue reports. If the OLT only allocates a limited number of time slots for reporting, the ONU should always report queue status for packets that are currently available at the ONU.

FIG. 13 illustrates an example data flow between an OLT and an ONU module according to one disclosed embodiment, showing how some fields are encoded. The ONU module 901 sends an enhanced REPORT message 1301 to the OLT 101 at t=t0. In the message, expecting with high confidence that data will be available for transmission to the OLT 101 at the future time t10, ONU module 901 reports that queue size of a queue 1 is “x” time slots at time t10. The Future Time field is therefore encoded with the value of v=t10−t0.

Suppose the OLT 101 receives the enhanced REPORT message at time t1 and decides to send a GATE message 1302 to ONU module 901 at time t2, and that the ONU module 901 receives this message at time t3. For simplicity, assume that the GATE message 1302 contains a single grant. Let the value of the “start time” of this grant be “d.” The ONU module 901 should transmit packets at t4, after a wait of d time slots (i.e. t4=t3+d). The OLT 101 will receive the data packets at t=t5.

Note that the time difference between the moment that the OLT 101 sends the GATE message 1302 and the moment that the OLT 101 receives data packets from ONU module 901 is t5−t2. This duration has three components: the time to transmit the GATE message from OLT 101 to CNU 901 (i.e. t3−t2), the waiting time at ONU module 901 (i.e. d=t4−t3), and the time to transmit the first time slot of data from ONU module 901 to OLT 101 (i.e. t5−t4). The sum of the first and the third components is the round trip delay (RTT) between OLT 101 and ONU module 901 (i.e. t5−t2=d+RTT). In the EPON standard, this quantity can be estimated using the time stamp field 406 in the multipoint control header 401. Thus, if OLT 101 wants to receive data packets from ONU module 901 at time t=t5, as this is the time that the network is free of other transmissions, then it should encode a value of d=t5−t2−RTT in the start time field 602 for the grant in the GATE message 600.

If the OLT 101 allocates a time slot so that the data arriving at t=t10 can also be transmitted, it is efficient to have t10≦t4 (i.e. all the data should be ready for transmission at t=t4). The value of t4−t0 can be readily estimated by the OLT 101. It consists of four components: The transmission time of the REPORT message 1301 from ONU module 901 to OLT 101 (i.e. t1−t0), the waiting time at OLT 101 (i.e. t2−t1), the transmission time of the GATE message 1301 from the OLT 101 to the ONU module 901 (i.e. t3−t2), and the waiting time at the ONU module 901 before data transmission, (i.e. t4−t3=d).

The first and third components together make up the RTT between the OLT 101 and the ONU module 901. Therefore, t4−t0=d+RTT+(t2−t1). The OLT 101 is aware of all the quantities in the equation. The condition t10≦t4 is equivalent to (t10−t0) (t4−t0), or (t10−t0)<d+RTT+(t2−t1). The quantity v=(t10−t0) is value that is encoded in the “future time” field of the queue report. Thus the condition becomes:

v≦d+RTT+(t2−t1),

which can be readily verified by the OLT 101. Therefore, once the OLT 101 determines when it wants to receive data, it can determine whether it should allocate resource, and how much, to transmit data that would arrive at the ONU module 901 after the ONU module 901 has sent the REPORT message 1301. This is a simple but effective way to use the “future time” parameter at the OLT. In related embodiments, the “future time” parameter is used in other ways (e.g., in predictive algorithms).

The following are some of the advantages of the embodiments described herein. Certain embodiments allow an ONU module at an interworking unit to report to an OLT when (and how much) data would be ready in the future, after the REPORT message is sent, specifying the condition that an OLT can readily check to determine the amount of resources that can be allotted for “future data” with little or no loss of bandwidth. This allows lower latency with little or no loss of bandwidth efficiency. Some embodiments do not preclude the OLT using prediction algorithms to further reduce the latency of the packets, but at the expense of possible bandwidth wastage. Related embodiments allow multiple interworking units and multiple regular CNUs to be connected on the same EPON. The EPoC networks attached to the interworking units can operate at different speeds. Since an ONU module in the interworking unit has the option to report “future data” at different future times, this information can be used by the OLT to predict better data arrivals at the ONU module, if so desired. The EPON and the CDNs that are attached downstream to the interworking unit are decoupled. Therefore, network maintenance procedures such as diagnostics are simplified. In addition, all the capabilities described herein are available in the EPON. The enhancements are modifications to the REGISTER-REQ message, and a new REPORT message. No assumption is made about the EPoC network. Thus, networks other than EPoC attached downstream to the interworking unit are contemplated, as long as the interworking unit is aware of, with high certainty, about data packets arriving from downstream in the future. Examples are other optical networks, non-cable-based wired networks and wireless networks.

Other embodiments exist as well. For example, the “future time” parameter in the enhanced REPORT message 1200 can be larger than one octet, and the format of the REGISTER-REQ message 1000 as well as the enhanced REPORT message 1200 can be different, etc.

FIG. 14 is a flow diagram of one embodiment of a method of interchanging data between an optical network and a CDN. The method begins in a start step 1410. In a step 1420, an interworking unit is caused to communicate with a plurality of CNUs via the CDN. In a step 1430, a message is generated in the interworking unit requesting registration of the interworking unit as an ONU in the optical network. In a step 1440, a speed of the CDN is reported via the optical network. In a step 1450, future data packets the interworking unit is expected to receive from the plurality of CNUs are reported via the optical network. As FIG. 14 indicates, the step 1450 may be repeated, perhaps many times, before re-registration is necessary or desired. In a step 1460, the interworking unit is caused to be re-registered when the speed changes. The method ends in an end step 1470.

Those skilled in the art to which this application relates will appreciate that other and further additions, deletions, substitutions and modifications may be made to the described embodiments.

What is claimed is:

1. An interworking unit, comprising:
a cable line terminal module operable to communicate with a plurality of cable network units via a cable distribution network; and
an optical networking unit module coupled to said cable line terminal module and operable to generate a message requesting registration of said interworking unit as an optical networking unit in an optical network and reporting a speed of said cable distribution network.

2. The interworking unit as recited in claim 1 wherein said optical networking unit module is operable to generate said message to an optical line terminal of said optical network.

3. The interworking unit as recited in claim 1 wherein a speed of said optical network and said speed of said cable distribution network are independent of one another.

4. The interworking unit as recited in claim 1 wherein said speed includes an upstream speed and a downstream speed.

5. The interworking unit as recited in claim 1 wherein said optical networking unit module is further operable to report via said optical network an availability of future data packets said interworking unit is expected to receive from said plurality of cable network units.

6. The interworking unit as recited in claim 1 wherein said optical network is an Ethernet-based passive optical network.

7. The interworking unit as recited in claim 1 wherein said cable distribution network is a coaxial-cable-based network.

8. A method of interchanging data between an optical network and a cable distribution network, comprising:
causing an interworking unit to communicate with a plurality of cable network units via said cable distribution network;
generating a message in said interworking unit requesting registration of said interworking unit as an optical networking unit in said optical network; and
reporting a speed of said cable distribution network via said optical network.

9. The method as recited in claim 8 wherein said generating comprises generating said message to an optical line terminal of said optical network.

10. The method as recited in claim 8 wherein a speed of said optical network and said speed of said cable distribution network are independent of one another.

11. The method as recited in claim 8 wherein said speed includes an upstream speed and a downstream speed.

12. The method as recited in claim 8 further comprising reporting via said optical network an availability of future data packets said interworking unit is expected to receive from said plurality of cable network units.

13. The method as recited in claim 8 wherein said optical network is an Ethernet-based passive optical network.

14. The method as recited in claim 8 wherein said cable distribution network is a coaxial-cable-based network.

15. An hybrid EPON-EPoC network, comprising:
a cable distribution network coupled to a plurality of cable network units;
an Ethernet-based passive optical network;
an interworking unit, including:
a cable line terminal module coupled to said cable distribution network and operable to allow said plurality of cable network units to communicate via said Ethernet-based passive optical network, and
an optical networking unit module operable to cause said interworking unit to be registered with an optical line terminal as an optical networking unit in said Ethernet-based passive optical network and report a speed of said cable distribution network to said optical line terminal.

16. The hybrid EPON-EPoC network as recited in claim 15 wherein a speed of said Ethernet-based passive optical network and said speed of said cable distribution network are independent of one another.

17. The hybrid EPON-EPoC network as recited in claim 15 wherein said speed includes an upstream speed and a downstream speed.

18. The hybrid EPON-EPoC network as recited in claim 15 wherein said optical networking unit module is further operable to report to said optical line terminal an availability of future data packets said interworking unit is expected to receive from said plurality of cable network units.

19. The hybrid EPON-EPoC network as recited in claim 15 wherein said cable distribution network is a coaxial-cable-based network.

20. The hybrid EPON-EPoC network as recited in claim 15 wherein said optical networking unit module is further operable to cause said interworking unit to be re-registered with said optical line terminal when said speed changes.
